(19) United States
(12) Patent Application Publication
(10) Pub. No.: US 2005/0126408 A1
(43) Pub. Date: Jun. 16, 2005

(54) All-in-one textile and media preparation machine for digital printing applications

(76) Inventors: Clement Michael Lavin, Sterling, MA (US); Mario Balducci, Sterling, MA (US)

Correspondence Address: C. MICHAEL LAVIN, 94 TUTTLE RD, STERLING, MA, 01564, US

(21) Appl. No.: 10/998,216

(22) Filed: Nov. 26, 2004

Related U.S. Application Data
(60) Provisional application No. 60/524,630, filed on Nov. 25, 2003.

(51) Int. Cl. B41F 1/40

(52) U.S. Cl. 101/345

(57) ABSTRACT

A machine that will coat, cure and laminate fabric, allowing the fabric to be Printed on using digital printing technology. A machine, the size of which, Allows for portability and use in a studio sized space. A very thin coating of An ink receptive liquid is deposited on one face of the fabric. Fabric is then Exposed to heat long enough to thoroughly cure and dry the fabric. The fabric Is then laminated with an adhesive paper on the non coated side and rolled up On a cylindrical core as a final product.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

For sometime the Textile, Apparel and Signage Industries have had the capability to utilize digital printing technology as an alternative to the traditional production methods, especially in the areas of Proofing, Sampling and Short-run Production.

Digital Textile Printing, however, has not received widespread acceptance, due, in a large part, to the lack of a simple and cost effective venue for the user to prepare and print on an adequate number of textile media, including his/her own textile fabrications. Proper preparation of textile media is essential to achieve acceptable printed output quality.

Each textile media requires specific treatment, based on the specific textile fibers and the type of digital printing fluid used. Up to now, the limited variety of treated media available and its cost have limited the use of digital printing on textiles. Most of the media available is “standard off the shelf” and is very costly.

Lack of availability and high cost cause the majority of potential users to continue to utilize analog processes to fulfill their needs, missing out on the many advantages presented by digital printing technology.

This invention has been developed specifically to help fill this void and to open up the possibilities for users to produce a large variety of digital-ready textiles for use in a large number of applications, including, but not limited to, signage production, apparel and home furnishing design, proofing and sample production.

### SUMMARY OF THE INVENTION

This invention will coat, cure and process fabric suitable for printing with ink on large format digital printers. Due to its small size, in comparison to currently available, single-purpose processing machines, this invention will offer users a studio-sized, multipurpose alternative. A variety of fabrics can also be processed, giving the user greater choice of media and the ability to change fabric types in a short time span.

### DESCRIPTION OF SEVERAL VIEWS OF THE DRAWING

FIG. 1 shows the main frame of the invention in a perspective view. Rollers depict its portability.

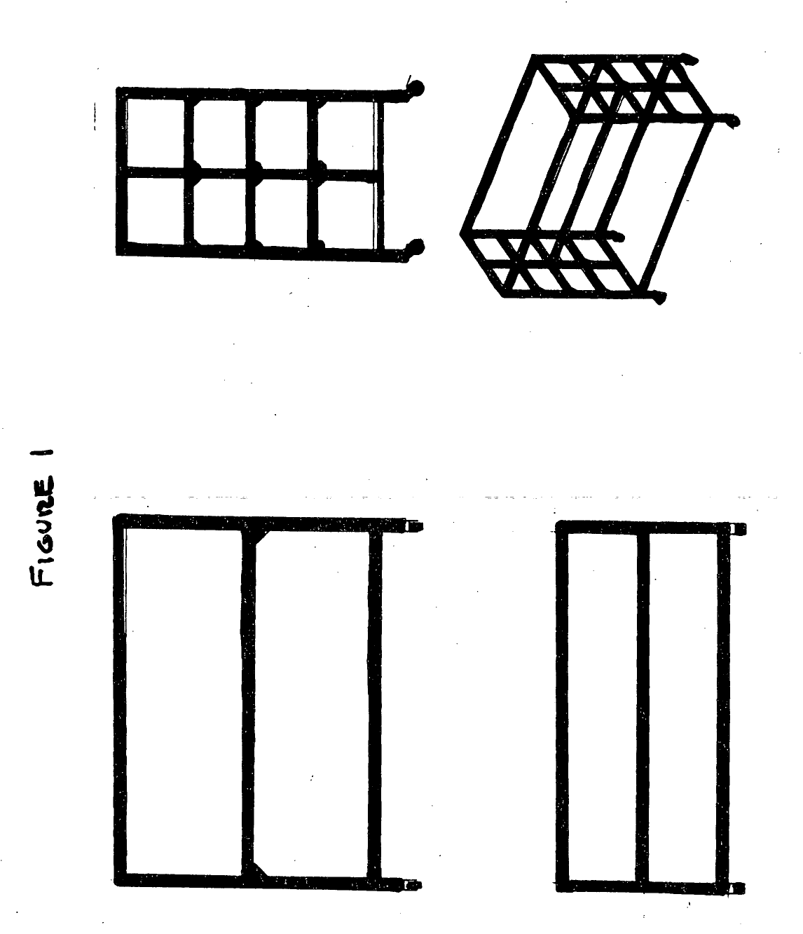

FIG. 2 shows an end view cut away of the inside of the machine indicating the approximate placement of component parts. The possible flow path of fabric is indicated. Also shown is an external mounting frame for rolls of fabric, the bottom roll feeding fabric into the machine and the upper most roll receiving the finished product as coated, cured and laminated fabric.

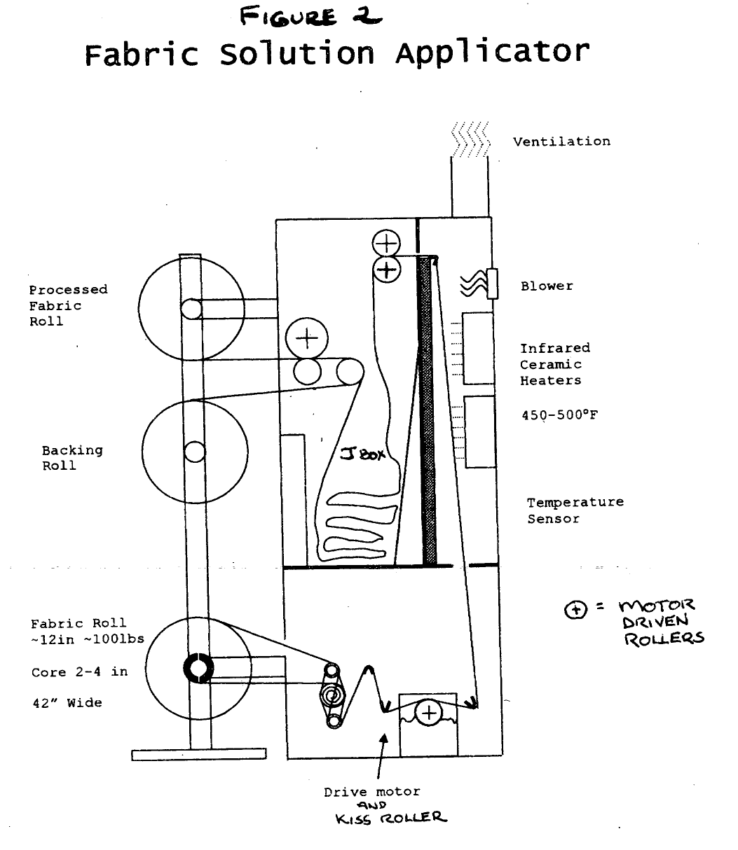

### DETAILED DESCRIPTION OF THE INVENTION

Coating and curing fabric for printing in large volume is currently accomplished on very large printing presses, most of which are overseas from the U.S. Small volume printing on such machines is neither cost effective nor geographically convenient to the user market, thus the need for digital printing and subsequent localized fabric preparation.

Current coating machines for the digital printing market are still too large and costly for design studio work spaces. The invention will allow users with limited space and budgets to process fabric in their local marketplace and thus be more responsive to market trends.

The invention will allow users to mount a roll of fabric or textile product of any width or length (also called “raw print media”) and to perform the following processes:

A. Preparation of Raw Textile Fabrics for Digital Printing.
This process is used to apply a uniform liquid ink-receptive coating, remove excess liquid and dry the fabric to the desired humidity content.

The machine is designed to use any ink-receptive coating that can be applied in a liquid form including preparations for reactive, acid, dispersed, pigmented, solvent-based and water-based inks. After the drying, the fabric (now digital print media) can be further laminated in the machine with An adhesive paper backing making the print media stiff and stable (no gathering or wrinkles) so it can be printed on with a large format digital printer. After laminating, the finished product is either rolled up on an external take up roller or fed directly into a digital printer, which could be mounted onto the machine or kept separate.

B. Post-Printing Color Fixation
The machine will fix or cure certain fabrics with certain ink types applied to obtain a permanent bond between the digitally printed media and the applied ink types. As an example, 100% polyester and polyester blended fabrics printed with dispersed inks can be fixed by applying heat at a specified temperature for a set period of time. Another example describes fabrics printed with pigmented inks, which also require exposure to heat in order to achieve a permanent bond. These curing processes are achieved by processing the fabric media through the machine drying and curing function.

The drawings describe these processes. A drive motor near the top of the machine draws untreated fabric mounted on an external roller rack into the base of the machine. A tensioning system maintains a steady pull on the fabric to keep it from being wrinkled as it passes over the powered kiss roller submerged in a bath of ink-receptive coating liquid.

The kiss roller applies a uniform coating of liquid to the fabric as it then proceeds up the machine through the heating and curing process. Here infrared heaters cure and dry the fabric which is then allowed to collect in the “J box” in the mid section of the machine. The fabric is then drawn up to the top of the machine by a powered take up roller and laminated with an adhesive paper roll mounted on the external roller rack.

The finished product is then rolled onto a take up roll mounted at the top of the external roller rack.

1. What we claim as our invention is a machine that, by virtus of its design, can, in a single, studio-sized package:
A apply a liquid treatment to organic, man made and blended textiles using a kiss roller technology then drying the materials using infrared fan assisted heaters:
B Cure, or dry, the coated media by running through a drying chamber.
C. Apply an adhesive laminate to the media, so that the finished product can be printed on a large format digital printer mounted either on the machine itself or left free standing.

2. As claimed in claim 1 above and the ability to use the drying function of the invention alone to set or fix pre-applied disperse or pigmented inks to polyester fabrics and polyester blends, creating a permanent, water resistant bond with the fabric.

3. As claimed in claim 1 above and the portability feature of the design, which allows the machine to be moved freely and to be rolled into a typical freight elevator.

4. As claimed in claim 1 above and the machine's ability to handle textile media both wound as a roll or in loose sheets of various width and length.

5. As claimed in claim 1 above and the machine's ability to dry the coated media in a single pass.

6. As claimed in claim 1 above and the machine's ability to apply a laminate material to the textile media and then re-roll the laminated media into rolls of variable width and length.

7. As claimed in claim 1 above and the ability of the machine to handle both rigid (Canvas, etc) and stretchable (Jersey, etc.) textile media.

8. As claimed in claim 1 above and the ability to automatically regulate the feed rate by sensing humidity levels in the textile being treated so that the proper lamination can take place.

9. As claimed in claim 1 above and the ability to feed the prepared textile media directly into a printer mounted on the machine itself or as stand alone.
